(19) United States
(12) Patent Application Publication
(10) Pub. No.: US 2012/0209678 A1
(43) Pub. Date: Aug. 16, 2012

(54) METHOD OF MARKETING AND PROMOTING FIRST AID KIT

(76) Inventor: Mark J. Miller, Vancouver, WA (US)

(21) Appl. No.: 13/396,418

(22) Filed: Feb. 14, 2012

Related U.S. Application Data
(60) Provisional application No. 61/442,591, filed on Feb. 14, 2011.

(51) Int. Cl. G06Q 30/06; G06Q 30/02

(52) U.S. Cl. 705/14.16; 705/26.61

(57) ABSTRACT

A method of distributing first aid kits includes providing a tool to a user. The tool includes a first list and a second list. The first list includes a plurality of different environments, and the second list includes a plurality of different first aid kits. Each of the plurality of environments is correlated to individual ones of the plurality of first aid kits. The tool identifies one of the plurality of first aid kits that is appropriate for use in a corresponding one of the plurality of environments. The method also includes receiving a communication from the user that the one of the plurality of first aid kits is desired. Furthermore, the method includes transferring to the user the one of the plurality of first aid kits.

### CROSS-REFERENCE TO RELATED APPLICATIONS

This application claims the benefit of U.S. Provisional Application No. 61/442,591, filed on Feb. 14, 2011. The entire disclosure of the above application is incorporated herein by reference.

### FIELD

The present disclosure relates to first aid kits and, more particularly, to a method of marketing and promoting first aid kits.

### BACKGROUND

This section provides background information related to the present disclosure which is not necessarily prior art.

First aid kits commonly include a container that is filled with bandages, antiseptics, pain relievers, splints, hot/cold packs, burn care products, and other first aid items. Different first aid kits can include different contents. Thus, some first aid kits may include items useful for treating some injuries but not others. For instance, while a first aid kit containing self adhesive bandages and over-the-counter pain relievers can be useful for treating minor medical conditions (e.g., minor cuts, headaches, etc.), the same kit may not be particularly useful for treating more severe conditions (e.g., a broken bone, etc.).

Also, effective marketing and promoting first aid kits to customers can be difficult. For instance, the marketer can sell a wide variety of first aid kits, and each first aid kit may include different respective contents. The consumer may need a first aid kit for use in a particular environment, but the consumer may not fully realize the potential injury risks at that particular environment. Thus, when presented with a wide variety of kits available for purchase, the consumer may have difficulty in selecting the correct kit for treating each of the reasonable foreseeable injuries.

### SUMMARY

This section provides a general summary of the disclosure, and is not a comprehensive disclosure of its full scope or all of its features.

A method of distributing first aid kits is disclosed that includes providing a tool to a user. The tool includes a first list and a second list. The first list includes a plurality of different environments, and the second list includes a plurality of different first aid kits. Each of the plurality of environments is correlated to individual ones of the plurality of first aid kits. The tool identifies one of the plurality of first aid kits that is appropriate for use in a corresponding one of the plurality of environments. The method also includes receiving a communication from the user that the one of the plurality of first aid kits is desired. Furthermore, the method includes transferring to the user the one of the plurality of first aid kits.

Additionally, a method of promoting a first aid kit within a computerized network of users is disclosed. The method includes making a content unit available to at least one of the users in the network. The content unit relates to the first aid kit. The method also includes detecting that the at least one user has informed another user of the existence of the content unit. Furthermore, the method includes providing a benefit to the at least one user as a reward for informing the other user of the existence of the content unit.

Moreover, a method of distributing first aid kits is disclosed that includes providing a tool to a user. The tool includes a first list and a second list. The first list includes a plurality of different foreseeable medical conditions, and the second list includes a plurality of different first aid kits. Each of the plurality of foreseeable medical conditions is correlated to individual ones of the plurality of first aid kits. The tool identifies one of the plurality of first aid kits that is appropriate for use in treating a corresponding one of the foreseeable medical conditions. Also, the method includes receiving a communication from the user that the one of the plurality of first aid kits is desired and transferring to the user the one of the plurality of first aid kits.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a system and method for distributing first aid kits according to exemplary embodiments of the present disclosure;

FIG. 2 is a schematic illustration of a system and method for virally advertising first aid kits according to exemplary embodiments of the present disclosure;

FIG. 3 is a graphical representation of the system of FIG. 1;

FIG. 4 is a perspective view of a first aid fit for use in the systems of FIGS. 1-3; and

FIG. 5 is a schematic illustration of a network of users that are part of the system of FIG. 2.

Corresponding reference numerals indicate corresponding parts throughout the several views of the drawings.

### DETAILED DESCRIPTION

Example embodiments will now be described more fully with reference to the accompanying drawings.

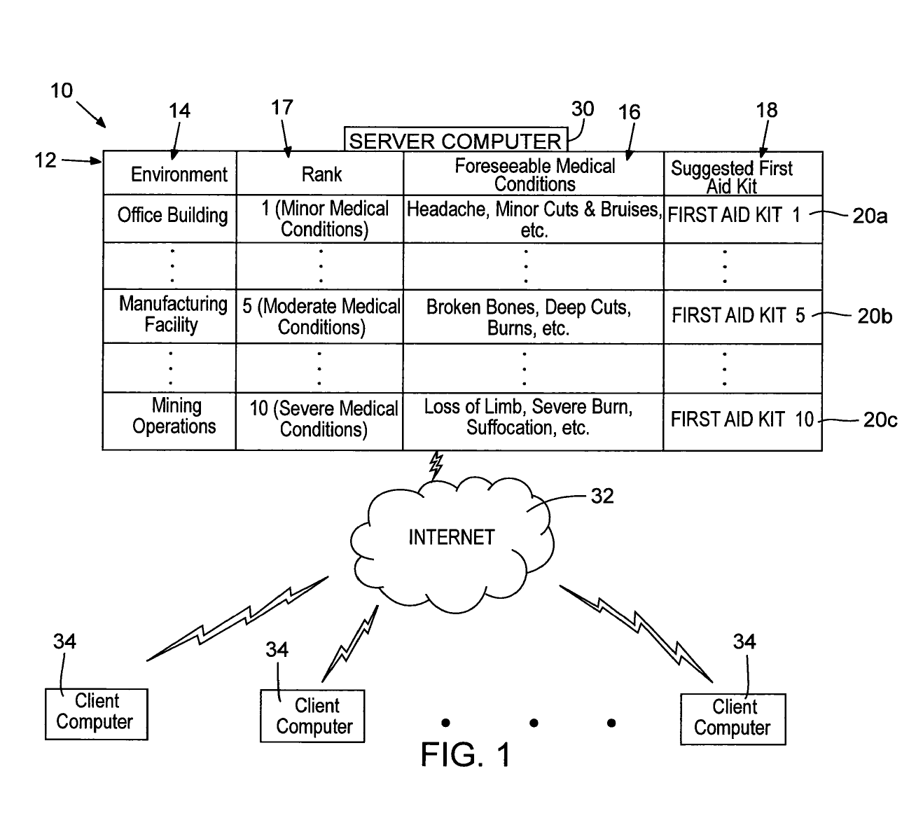

Referring now to FIG. 1, a system 10 and method of marketing and promoting first aid kits is illustrated schematically. As shown in FIG. 1, the system 10 can include a marketing tool 12 that can be provided to a user (e.g., a customer that is considering purchasing one of the first aid kits). The tool 12 can be included in printed or electronic advertising or promotional literature as will be discussed. Thus, as will be discussed, the tool 12 can assist the user by identifying which of the first aid kits is appropriate for use in the user's particular environment. For instance, if the user wants to purchase a first aid kit for the user's place of employment (i.e., the user's work environment), the tool 12 can help the user identify the first aid kit that includes the necessary contents for that type of work environment.

The tool 12 can include a first list 14 of different environments in which first aid kits might be used. In the embodiments shown, the first list 14 can include different work environments, such as “office building,” “manufacturing facility,” and “mining operation.” The first list 14 can include any number of different work environments with any suitable level of specificity. Also, the first list 14 can include environments other than work environments without departing from the scope of the present disclosure.

The tool 12 can also include a second list 16 of different medical conditions or injuries, and each can be grouped, arranged, and ranked according to severity. For instance, the second list 16 can include “minor medical conditions” (i.e., those which cause mild discomfort and may need eventual medical care, etc.), such as headaches, minor cuts and bruises, etc. The second list 16 can additionally include “moderate medical conditions” (i.e., those which cause great pain and will likely require immediate medical care, etc.), such as broken bones, deep cuts, burns, etc. Furthermore, the second list 16 can include “severe medical conditions” (i.e., those that are life threatening), such as loss of a limb, severe burns, suffocation, etc. The second list 16 can include any number of different medical conditions or injuries with any suitable level of specificity. As will be discussed, each of the medical conditions or injuries within the second list 16 can be correlated to individual ones of the different environments included in the first list 14. For instance, the lists 14, 16 can be correlated such that the medical conditions/injuries of the second list 16 are the reasonably foreseeable medical conditions/injuries that could occur in each environment of the first list 14.

Furthermore, the entries in the second list 16 can be identified by a ranking 17 (i.e., a “severity ranking”). The ranking 17 can include numbers and/or letters (i.e., alphanumeric ranking), and/or the ranking 17 can include pictures, icons, etc. (i.e., pictographic ranking). In the embodiments illustrated, the ranking 17 includes the number “1” to identify the “minor medical conditions,” the number “5” to identify the “moderate medical conditions,” and the number “10” to identify the “severe medical conditions.” It will be appreciated that the ranking 17 can be effective shorthand for representing the level of severity of the different medical conditions.

As shown in FIG. 1, the different environments listed within the first list 14 are correlated to the different medical conditions within the second list 16. For instance, it will be appreciated that an office building (listed in the first list 14) is a relatively safe work environment as compared to a manufacturing facility, and the manufacturing facility is typically safer than working in a mining operation. This is due to the nature of the work performed, the types of tools and implements that are used by the workers, etc. Thus, reasonably foreseeable injuries and medical conditions occurring in an office building are likely to be relatively minor as compared to the reasonably foreseeable injuries occurring in a manufacturing facility, and the reasonably foreseeable medical conditions occurring in the manufacturing facility are likely to be less severe than those occurring at a mining operation. Accordingly, this correlation is reflected in the arrangement of the first and second lists 14, 16 into defined rows and columns within the marketing tool 12.

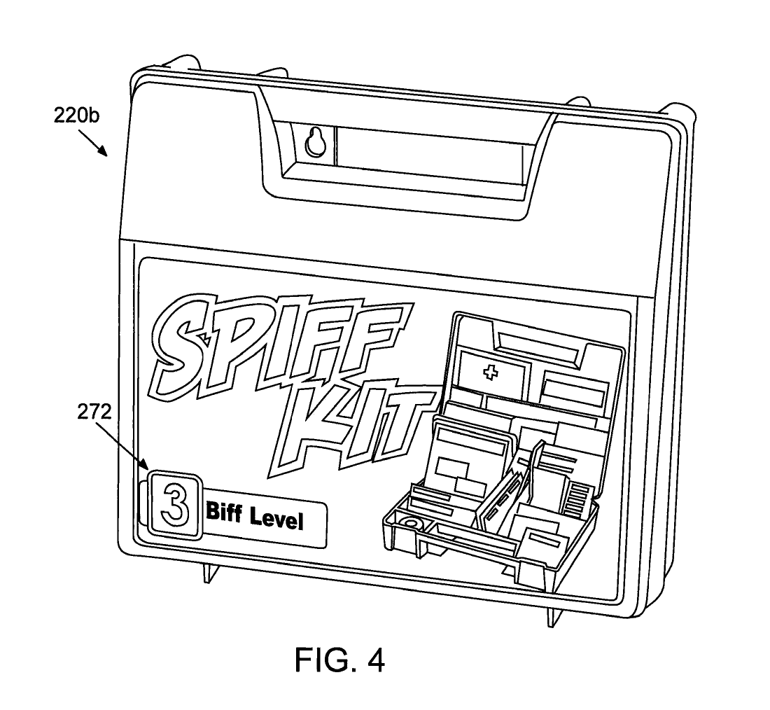

The marketing tool 12 can additionally include a third list 18 of different commercially available first aid kits 20a, 20b, 20c. The first aid kits 20a, 20b, 20c can each include a respective case or other housing, and the kits 20a, 20b, 20c can have different contents (see, e.g., FIG. 4). For instance, the first aid kit 20a can include pain relievers, bandages, and similar items for treatment of headaches, minor cuts, and other relatively minor medical conditions (e.g., headaches, minor cuts and bruises, etc.). The second first aid kit 20b can include splints, burn dressings, and other items for treatment of more serious medical conditions (e.g., broken bones, sprains, deep skin lacerations, burns, etc.). The third first aid kit 20c can include a tourniquet, CPR or resuscitation tools, and other items for treatment of severe (e.g., life threatening) medical conditions. The third list 18 can also include detailed descriptions of the contents of each of the first aid kits 20a, 20b, 20c.

As shown in FIG. 1, the different environments listed within the first list 14 and the different medical conditions listed within the second list 16 can be correlated to the different first aid kits 20a, 20b, 20c listed within the third list 18. (The lists 14, 16, 18 are arranged in columns and are correlated by row in the embodiments of FIG. 1.) Thus, as shown, the marketing tool 12 can indicate to the user that the contents in the first aid kit 20a should be appropriate for treating the relatively minor medical conditions (rank 1) that are foreseeable in an office building working environment. Also, the marketing tool 12 can indicate that the contents in the first aid kit 20b should be appropriate for treating the moderate medical conditions (rank 5) that are foreseeable in a manufacturing facility working environment. Moreover, the marketing tool 12 can indicate that the contents in the first aid kit 20c should be appropriate for treating the severe medical conditions (rank 10) that are foreseeable in a mining operation work environment.

Also, the first aid kits 20a, 20b, 20c can include an identifier. For instance, in the embodiments illustrated, the first aid kit 20a can be identified as “First Aid Kit 1,” the first aid kit 20b can be identified as “First Aid Kit 5,” and the first aid kit 20c can be identified as “First Aid Kit 10.” Thus, the numbers included in these identifiers can correspond to the associated rank 17. Accordingly, the first aid kits 20a, 20b, 20c can each be identified according to the severity of injuries that are treatable therewith.

It will be appreciated that there can be any number of different first aid kits 20a, 20b, 20c with any suitable type of contents. Also, it will be appreciated that the kit 20b could include at least some of the same contents as kit 20a as well as additional contents for treatment of both minor and more serious injuries. Likewise, the kit 20c could include at least some of the same contents as the kit 20a and/or the kit 20b and can also include additional contents for treatment of minor, serious, and severe injuries.

The tool 12 can be printed (e.g., in catalogs or other promotional materials). Also, the tool 12 can be electronically displayed, can be an audible recording, or can be otherwise recorded and reproduceable. Also, the tool 12 can be made publically available via printed publication, via a computerized network 32 (e.g., internet, intranet, etc.), or any other means.

In some embodiments of the system 10 (illustrated schematically in FIG. 1), a server computer 30 can electrically transmit data relating to the tool 12 over a computerized network 32 such that the tool 12 can be displayed (e.g., as a webpage) on one or more client computers 34. The tool 12 can be interactive such that the user can select certain information (e.g., by “clicking” on the information with a computer mouse, etc.). Also, the tool 12 can include additional information, such as a list of the exact contents of each first aid kit 20a, 20b, 20c, prices, instructions for treating certain injuries, etc. Moreover, payment or other information can be transmitted from one or more of the client computers 34 to the server computer 30 for purchasing one or more of the first aid kits 20a, 20b, 20c.

During use, one or more users of the client computers 34 can access the tool 12 (e.g., view a webpage containing the tool 12), and the user(s) can identify which of the environments in the first list 14 and which of the first aid kits in the list 18 is most appropriate for his/her particular needs. For instance, if the user works in a manufacturing facility, the user can select the fourth row as being most appropriate. This selection can trigger communication from the client computer 34 to the server computer 30 that the user desires to purchase the first aid kit 20b. Payment information, shipping information, or other information can also be transmitted from the client computer 34 to the server computer 30. Then, the first aid kit 20b can be transferred to the user by mail or otherwise to complete the transaction.

Accordingly, the system 10 and the tool 12 can help the user when selecting an appropriate first aid kit 20a, 20b, 20c for purchase. This is because the different kits 20a, 20b, 20c are organized according to the different environments and different risks associated with each. Also, the system 10 can normalize the different environments and the different levels of injury risk associated with each into an easily understandable scale.

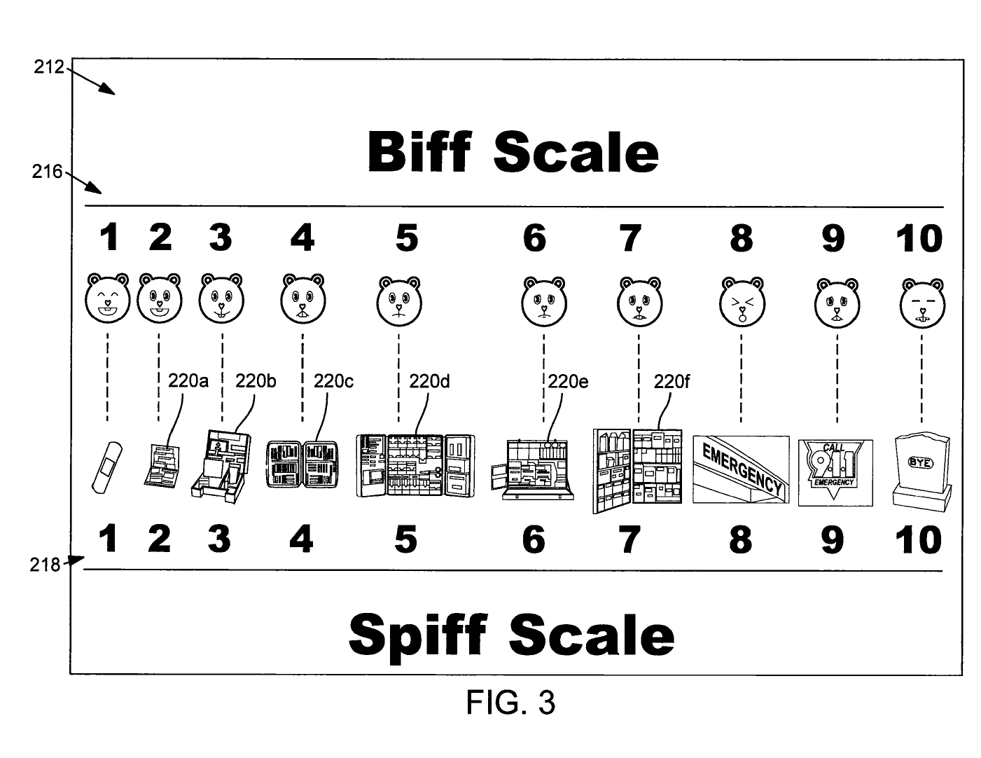

Referring now to FIGS. 3 and 4, additional aspects of the present disclosure will be discussed. Features that correspond to the embodiments of FIG. 1 are indicated by corresponding reference numbers increased by 200.

As shown in FIG. 3, a tool 212 can be presented, which includes rankings of injury severity and treatments, similar to the embodiments discussed above. The rankings can include a first list or first scale 216 and a second list or second scale 218.

The scale 216 (e.g., a so-called “Biff Scale”) can set forth different injuries of different severity. The different injuries can be sequentially arranged from least severe (e.g., at level 1) to most severe (e.g., at level 10). The scale 216 can include a numeric ranking as well as a symbolic (i.e., pictographic) ranking. For instance, the scale 216 can include a cartoon bear's face with varying expressions. The expression on the bear's face can “change” from fairly happy (e.g., at level 1) to extremely pained or even dead (e.g., at level 10). It will be appreciated that the scale 216 can include any suitable symbol for representing the severity of the injuries along the scale 216.

The scale 218 (e.g., a so-called “Spiff Scale”) can set degrees of care or treatment for the injuries within the scale 216. The different treatments can be sequentially arranged from least serious (e.g., at level 1) to most serious (e.g., at level 10). The scale 218 can include a numeric ranking as well as a symbolic (i.e., pictographic) ranking. For instance, a self-adhesive bandage is illustrated at level 1 for treating the minor injuries associated therewith. Also, different commercially available first aid kits 220a-220f are illustrated at levels 2-7, respectively, for treating the injuries associated therewith. The contents of the first aid kits 220a-220f are increasingly complex as arranged within the scale 218. For instance, the first aid kit 220a illustrated for use at level 2 can include fairly simple implements for treating the relatively minor injuries associated therewith; however, the first aid kit 220f illustrated for use at level 7 can include relatively complex implements for treating the more severe injuries associated therewith.

The scale 216 and the scale 218 can be correlated as shown in FIG. 3. Accordingly, the tool 212 can help the user to decide which of the first aid kits 20a-20f to purchase based on the severity of the injuries expected. Also, the tool 212 can establish a helpful standard for identifying the severity of different injuries.

Moreover, as represented in FIG. 4, the first aid kits 220b can include the corresponding severity ranking 272 from the scale 216 of the tool 212 of FIG. 3. For instance, as shown in FIG. 3, the first aid kit 220b can be useful for treating injuries at level 3 of the scale 216, and as shown in FIG. 4, this level 3 “Biff Level” can be printed on the label of the first aid kit 220b. It will be appreciated that the other first aid kits 220a, 220c-220f can also each include respective rankings 272. Accordingly, the rankings 272 can serve as useful identifiers for the user and further help establish a standard for grading the severity of different injuries.

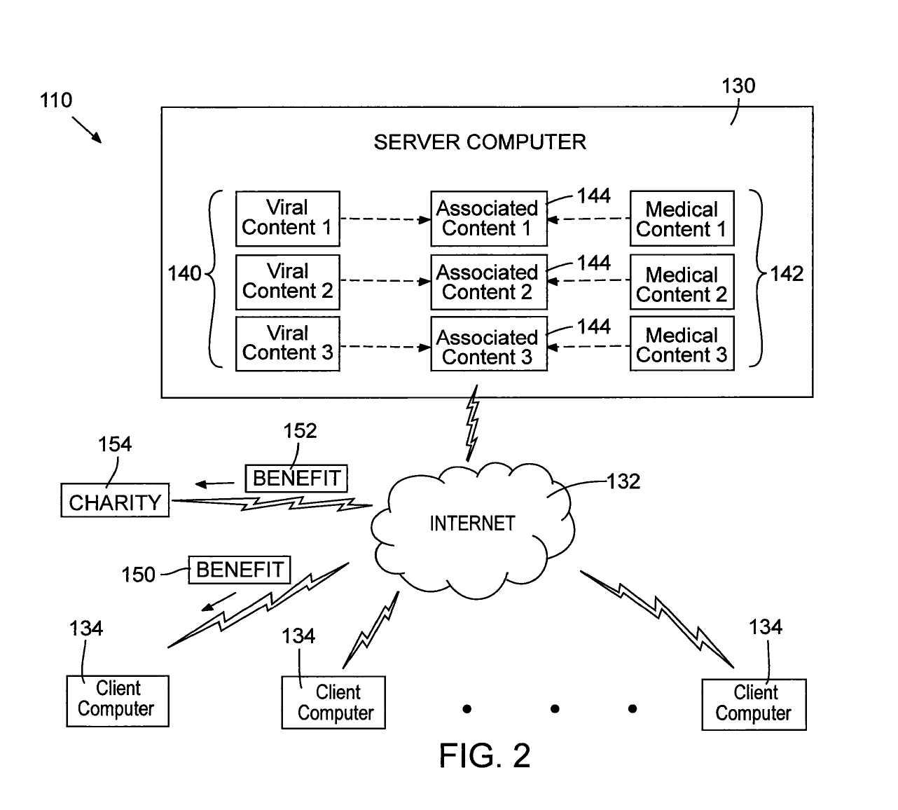

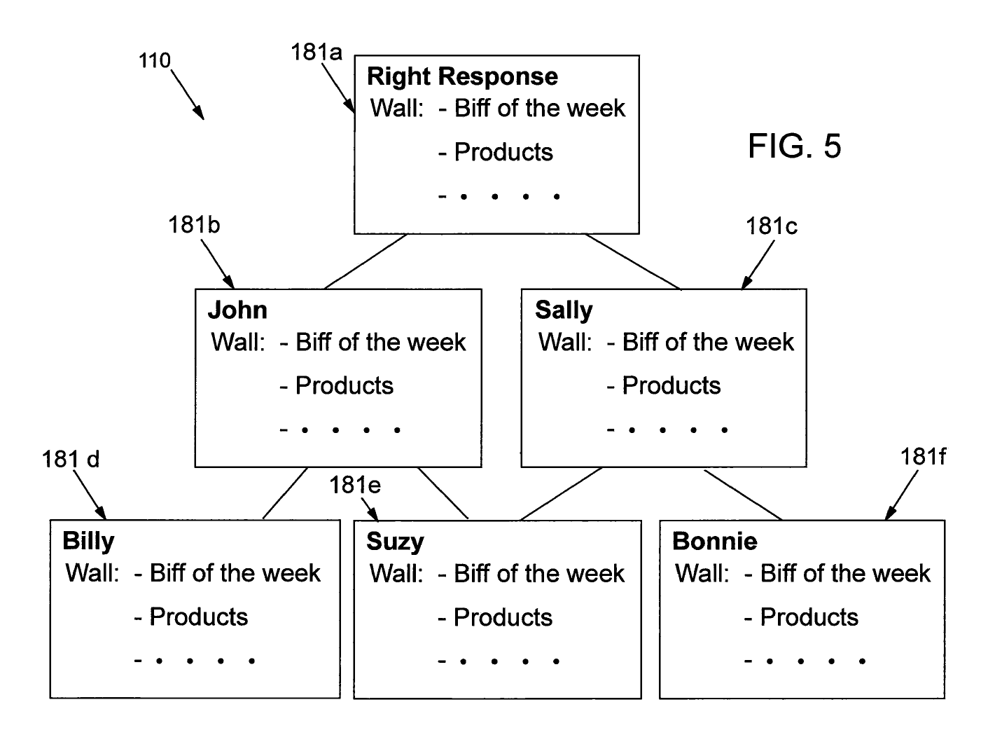

Referring now to FIGS. 2 and 5, the system 110 and its method of use for promoting first aid kits will now be discussed according to additional exemplary embodiments. As will be described in detail, viral content 140 (e.g., videos, pictures, text, etc.) can be associated with related medical content 142 (e.g., information about particular first aid kits, medical tools, medical care, etc.) and the content 140, 142 can be transmitted virally between different client computers 134 within a computerized network. This can help promote certain first aid kits as will be discussed, can help educate users, etc. Also, users that pass along content 140, 142 to other users within the unit can benefit directly as will be discussed, or third parties (e.g., charitable organizations) can benefit as a result of this exchange of information. Features of the embodiments of FIG. 2 that are similar to those of FIG. 1 are identified by similar reference numerals increased by 100.

As shown in FIG. 2, the server computer 130 can include the viral content 140 and medical content 142 stored thereon in memory. In other embodiments, the server computer 130 can have access to the content 140, 142, which is stored elsewhere (e.g., “in the cloud” for cloud computing). The viral content 140 can be videos, pictures, text, etc. illustrating various injuries or other medical conditions. In some embodiments, the viral content 140 can be humorous, instructive, etc. Also, the viral content 140 can show and/or describe certain injuries. For instance, the viral content 140 can be staged or scripted videos, can be impromptu videos of real events, or can be of another type. On the other hand, the medical content 142 can be advertisements about particular first aid kits or other medical equipment or can be instructional videos on how to treat particular medical conditions with particular medical equipment. The medical content 142 can be staged and scripted videos that are filmed completely separate from the viral content 140.

Particular pieces of viral content 140 and particular pieces of medical content 142 can be associated at the server computer 130 into associated content 144 (i.e., content units). For instance, in some embodiments, the content 140, 142 can be associated such that a single video showing an injury (from the viral content 140) is immediately followed by an advertisement of a first aid kit that can treat that injury (from the medical content 142). In one particular example, a video (from the viral content 140) of a person accidentally spraining an ankle can be immediately followed by a video advertisement (from the medical content 142) of a first aid kit that includes a splint, pain relievers, and other items used for treating the injury. Accordingly, the viral content 140 can entertain the viewer while the medical content 142 can educate the viewer. Each piece of viral content 140 can be similarly associated with corresponding pieces of medical content 142 to thereby define a plurality of pieces of associated content 144.

The client computers 134 can have access to the associated content 144 over the computerized network 132 for viewing. For instance, the associated content 144 can be made available over a webpage or website, such as youtube.com, etc. Also, the client computers 134 can be in communication with each other over the network 132. In some embodiments, this client-to-client communication can occur over a social media website, such as facebook.com, plus.google.com, twitter.com, myspace.com, etc.

During use, the users of the client computers 134 can inform other users of the existence of particular associated content 144. For instance, the users can send the associated content 144 to one another via e-mail. Also, in the case of facebook.com, one user can “post” the associated content 144 on his or her “facebook wall” for other users to view. Then, those other users can access and view the associated content 144 by viewing both the viral content 140 and medical content 142 included therein. Those users may then pass along the piece of associated content 144 to still other users such that the associated content 144 is communicated virally. Accordingly, the system 110 can provide entertaining and informative content and can provide an effective means of advertising the medical products detailed in the medical content 142.

Moreover, in some embodiments, those users that transmit or otherwise notify other users of the associated content 144 can receive one or more benefits 150 as a reward for doing so. The server computer 130 can monitor and detect which users have passed on the content 144, and benefits 150 can be distributed accordingly. The benefits 150 can be coupons or discounts for the medical products detailed in the medical content 142.

For instance, a first user of the client computers 134 can register with the host associated with the server computer 130. Then, when the first user transmits the associated content 144 to a second user, the host associated with the server computer 130 can transmit the benefit 150 to the first user. In some embodiments, the benefit 150 is transferred to the first user only if the second user actually accesses (e.g., watches) the particular associated content 144.

In still other embodiments, benefits 152 can also be transferred to a third party, such as a charitable organization 154 or other entity. In other words, a first user of one of the client computers 134 can notify a second user of another client computer 134 about a particular piece of associated content 144, and the first user can do so on behalf of the charity 154. For instance, if the user makes the associated content 144 available to another (e.g., by posting the particular piece of associated content 144 on his or her “facebook wall”), the user can also make it known that the charity 154 will receive a particular monetary donation every time the particular piece of associated content 144 is viewed. Then, the host associated with the server computer 130 can send the benefit 152 (e.g., a donation) to the designated charity 154. The monetary value of the benefit 152 can depend on the number of views that the associated content 144 receives, or the value can be determined otherwise.

FIG. 5 illustrates additional features of the system 110 and its method of use. FIG. 5 illustrates the system 110 in the context of the facebook.com social media website. However, it will be appreciated that the system 110 could be implemented using other websites, such as youtube.com, plus.google.com, twitter.com, myspace.com, etc.

As shown in FIG. 5, the system 110 can include a number of users 181a, 181b, 181c, 181d, 181e, 181f. The user 181a can be a “host” that initially makes the content 144 available. The users 181b and 181c can be first level “friends,” such that they are directly associated with the user 181a. The users 181d and 181e can be first level “friends” to the user 181b, and the users 181e and 181f can be first level “friends” as well. The users 181d, 181e, 181f can be second level “friends” of the user 181a because they are indirectly associated with the user 181a via the users 181b, 181c.

The user 181a can be a charitable organization, for instance, identified by the “RightResponse” moniker. The user 181a can provide a link to the viral content 140, to the medical content 142, and/or the associated content 144 available from the server computer 130 as discussed above. For instance, the user 181a can provide a link to a “Biff of the Week,” which might include a video of a person getting injured and then a subsequent advertisement or educational video demonstrating how to treat that injury using an advertised first aid kit.

Then, other users 181b, 181c that are directly connected to the user 181a can pass on the content 144 from the user 181a, for instance, by re-posting the content 144, providing commentary about the content 144, judging the content 144, etc. Specifically, users 181b, 181c can be included within the group of friends of user 181a, and by re-posting, commenting, or judging the content, the users 181b, 181c can virally spread the content to other users 181d, 181e, 181f outside the group of friends of user 181a. Additionally, the content can be spread virally to still other users. Moreover, when the content is re-posted, when the users 181b-181f comment on the content, and/or when the users 181b-181f judge the content, charitable proceeds can be directed back and paid to the user 181a. Also, if one of the users 181b-181f re-posts, comments on, or judges the content originally posted by user 181a, the users 181b-181f can be automatically registered by user 181a. Subsequently, the users 181b-181f can be automatically sent catalogs, promotional materials, free samples, etc.

Accordingly, the system 110 discussed above can provide an effective means of advertising first aid kits and other medical products by associating those products with popular viral content. This type of advertising can be relatively inexpensive. Also, the advertising can be subtle because the promotional information can follow an entertaining video, etc. Moreover, the advertising can be effective since it can come as a result of a friend's recommendation or suggestion. In addition, the advertising can have the added benefit of generating donations to particular charities.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of distributing first aid kits comprising:
providing a tool to a user, the tool including a first list and a second list, the first list including a plurality of different environments, the second list including a plurality of different first aid kits, each of the plurality of environments being correlated to individual ones of the plurality of first aid kits, the tool identifying one of the plurality of first aid kits that is appropriate for use in a corresponding one of the plurality of environments;
receiving a communication from the user that the one of the plurality of first aid kits is desired; and
transferring to the user the one of the plurality of first aid kits.

2. The method of claim 1, wherein providing the tool further comprises providing to the user a third list, the third list including a plurality of different foreseeable medical conditions, each of the plurality of foreseeable medical conditions being correlated to individual ones of the plurality of different environments.

3. The method of claim 2, wherein providing the tool further comprises providing to the user a severity ranking of each of the plurality of foreseeable medical conditions.

4. The method of claim 3, further comprising including on each of the plurality of first aid kits the corresponding severity ranking.

5. The method of claim 3, wherein the ranking is at least one of alphanumeric and pictographic.

6. The method of claim 3, wherein each first aid kit has an identifier, and wherein the identifier includes the corresponding severity ranking.

7. The method of claim 1, wherein the second list includes a first first aid kit with first contents, a second first aid kit with second contents, and a third first aid kit with third contents, the second first aid kit operable to treat more severe injuries than the first first aid kit, the third first aid kit operable to treat more severe injuries than the second first aid kit, the third contents including at least some of the second contents and at least some of the first contents, the second contents including at least some of the first contents.

8. The method of claim 1, wherein providing the tool includes transmitting electronic data relating to the tool from a server computer to a client computer, and displaying the tool on a display of the client computer.

9. The method of claim 1, wherein providing the tool includes transmitting electronic data relating to the tool from a server computer to a plurality of client computers that are interconnected within a computerized network, and displaying the tool on a display of at least one of the plurality of client computers.

10. A method of promoting a first aid kit within a computerized network of users, the method comprising:
making a content unit available to at least one of the users in the network, the content unit relating to the first aid kit;
detecting that the at least one user has informed another user of the existence of the content unit; and
providing a benefit to the at least one user as a reward for informing the other user of the existence of the content unit.

11. The method of claim 10, wherein the benefit is at least one of a coupon relating to the first aid kit and a discount for purchasing the first aid kit.

12. The method of claim 10, wherein the content unit includes viral content and medical content that relate to each other.

13. The method of claim 10, wherein the viral content includes at least one of a still-life image of an injury and a moving image of the injury, and wherein the medical content includes information about how the first aid kit can treat the injury.

14. The method of claim 10, wherein the computerized network includes a host, a first level of client computers of first users that are associated directly with the host, and a second level of client computers of second users that are associated indirectly with the host via at least one of the first level of client computers, and wherein detecting that the at least one user has informed another user of the existence of the content unit includes detecting that at least one of the first users has informed at least one of the second users of the existence of the content unit.

15. The method of claim 10, further comprising providing a benefit to a third party on behalf of the at least one user.

16. The method of claim 15, wherein the third party is a charitable organization.

17. The method of claim 15, wherein the third party is within the computerized network of users.

18. A method of distributing first aid kits comprising:
providing a tool to a user, the tool including a first list and a second list, the first list including a plurality of different foreseeable medical conditions, the second list including a plurality of different first aid kits, each of the plurality of foreseeable medical conditions being correlated to individual ones of the plurality of first aid kits, the tool identifying one of the plurality of first aid kits that is appropriate for use in treating a corresponding one of the foreseeable medical conditions;
receiving a communication from the user that the one of the plurality of first aid kits is desired; and
transferring to the user the one of the plurality of first aid kits.

19. The method of claim 18, wherein providing the tool further comprises providing to the user a third list, the third list including a plurality of different environments, each of the plurality of foreseeable medical conditions being correlated to individual ones of the plurality of different environments.

20. The method of claim 18, wherein providing the tool further comprises providing to the user a severity ranking of each of the plurality of foreseeable medical conditions, and further comprising including on each of the plurality of first aid kits the corresponding severity ranking.
